(19) United States
(12) Patent Application Publication
(10) Pub. No.: US 2015/0340734 A1
(43) Pub. Date: Nov. 26, 2015

(54) LITHIUM IONIC CONDUCTOR, FABRICATION METHOD THEREFOR AND ALL-SOLID LITHIUM SECONDARY BATTERY

(71) Applicant: FUJITSU LIMITED, Kawasaki-shi (JP)

(72) Inventors: Kenji Homma, Atsugi (JP); Satoru Watanabe, Atsugi (JP)

(21) Appl. No.: 14/817,338

(22) Filed: Aug. 4, 2015

Related U.S. Application Data
(63) Continuation of application No. PCT/JP2013/053759, filed on Feb. 15, 2013.

(51) Int. Cl. H01M 10/0562; H01M 10/0525

(52) U.S. Cl. CPC H01M 10/0562; H01M 10/0525; H01M 2300/0068

(57) ABSTRACT

A lithium ionic conductor (solid electrolyte) includes lithium (Li), phosphorus (P), boron (B) and sulfur (S) as constituent elements and includes a crystal structure including a crystal lattice of a monoclinic system.

### CROSS-REFERENCE TO RELATED APPLICATION

This application is a continuation application of International Application PCT/JP2013/053759 filed on Feb. 15, 2013 and designated the U.S., the entire contents of which are incorporated herein by reference.

### FIELD

The embodiments discussed herein are related to a lithium ionic conductor, a fabrication method for a lithium ionic conductor and an all-solid lithium secondary battery.

### BACKGROUND

A secondary battery that is safe and has high reliability under all global environment is demanded for an energy harvesting technology in which electricity generated from minute energy such as sunlight, vibration or the body temperature of a person or an animal is accumulated and utilized for a sensor or wireless transmission power.

It is concerned that, in liquid-based secondary batteries that are widely utilized at present, if the number of utilization cycles increases, then a positive electrode active material may degrade and the battery capacity may decrease or organic electrolyte in the battery may be ignited by battery short-circuiting caused by formation of dendrite.

Therefore, secondary batteries of the liquid-based electrolyte are poor in the reliability and the safety, for example, where it is intended to use the secondary batteries in an energy harvesting device whose utilization for 10 years or more is expected.

Therefore, attention is paid to an all-solid lithium secondary battery wherein all of constituent materials are solid materials. The all-solid lithium secondary battery has no possibility of liquid leakage or ignition and is superior also in a cycle characteristic.

For example, as a solid electrolyte used for the all-solid lithium secondary battery, for example, as a lithium ionic conductor, Li₂S—B₂S₃-based (Li₃BS₃), Li₂S—P₂S₃-based (Li₇P₃S₁₁, Li₃PS₄, Li₈P₂S₆ or the like), Li₂S—B₂S₅—X (LiI, B₂S₃, Al₂S₃, GeS₂)-based (Li_{4-X}Ge_{1-X}P_{X}S₄) and Li₂S—B₂S₃—LiI-based electrolytes and so forth are available. Also a solid electrolyte having Li and S and having an element such as P, B and O as occasion demands (Li₇P₃S₁₁, Li₂S, Li₃PO₄—Li₂S—B₂S₃ system, 80Li₂S-20P₂S₅ or the like) is available.

### SUMMARY

The lithium ionic conductor includes lithium (Li), phosphorus (P), boron (B) and sulfur (S) as constituent elements and includes a crystal structure including a crystal lattice of a monoclinic system.

The lithium ionic conductor includes lithium (Li), phosphorus (P), boron (B) and sulfur (S) as constituent elements, and includes, in X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

The lithium ionic conductor includes a composition represented by Li_{3+3/4x}BₓP_{1-3/4x}S₄ (0.6≦x≦1.1).

The all-solid lithium secondary battery includes a positive electrode, a negative electrode, and a solid electrolyte that is provided between the positive electrode and the negative electrode, contains lithium (Li), phosphorus (P), boron (B) and sulfur (S) as constituent elements and has a crystal structure including a crystal lattice of a monoclinic system.

The all-solid lithium secondary battery includes a positive electrode, a negative electrode, and a solid electrolyte that is provided between the positive electrode and the negative electrode, contains lithium (Li), phosphorus (P), boron (B) and sulfur (S) as constituent elements and has, in X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

The all-solid lithium secondary battery including a positive electrode, a negative electrode, and a solid electrolyte provided between the positive electrode and the negative electrode and having a composition represented by Li_{3+3/4x}BₓP_{1-3/4x}S₄ (0.6≦x≦1.1).

The fabrication method for a lithium ionic conductor includes mixing lithium (Li), phosphorus (P), boron (B) and sulfur (S), melting the mixture by heating, and quenching the melted mixture to fabricate a solid electrolyte having a crystal structure including a crystal lattice of a monoclinic system.

The fabrication method for a lithium ionic conductor includes mixing lithium (Li), phosphorus (P), boron (B) and sulfur (S), melting the mixture by heating, and quenching the melted mixture to fabricate a solid electrolyte having, in X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

The fabrication method for a lithium ionic conductor includes mixing lithium (Li), phosphorus (P), boron (B) and sulfur (S), melting the mixture by heating, and quenching the melted mixture to fabricate a solid electrolyte having a composition represented by Li_{3+3/4x}BₓP_{1-3/4x}S₄ (0.6≦x≦1.33).

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic sectional view depicting a configuration of an all-solid lithium secondary battery according to a present embodiment.

FIG. 2 is a view depicting weighing values of raw materials where the lithium ionic conductors (solid electrolytes) of the examples and comparative examples are fabricated.

FIG. 3 is a view depicting diffraction diagrams obtained by powder X-ray diffraction measurement of the lithium ionic conductors (solid electrolytes) of the examples and comparative examples.

FIG. 4 is a view depicting diffraction diagrams obtained by powder X-ray diffraction measurement of the lithium ionic conductors (solid electrolytes) of the examples and comparative examples.

FIG. 5 is a view depicting a diffraction diagram obtained by synchrotron X-ray diffraction measurement of the lithium ionic conductor (solid electrolyte) of the example 4.

FIG. 6 is a view illustrating lattice constants of the lithium ionic conductors (solid electrolytes) of the present examples and comparative examples.

FIG. 7 is a view depicting spectrum data obtained by infrared spectrometry of the lithium ionic conductor (solid electrolyte) of the example 4.

FIG. 8 is a view illustrating a calculation method for an ionic conductivity of the lithium ionic conductors (solid electrolytes) of the examples and comparative examples.

FIG. 9 is a view depicting ionic conductivities of the lithium ionic conductors (solid electrolytes) of the examples and comparative examples.

FIGS. 10A and 10B are views illustrating a fabrication method for the all-solid lithium secondary batteries of the examples.

FIG. 11 is a view depicting a discharge curve of the all-solid lithium secondary battery of the example.

### DESCRIPTION OF EMBODIMENTS

Incidentally, in order to improve an output characteristic (load characteristic) of an all-solid lithium secondary battery, the internal resistance of the secondary battery is reduced. The internal resistance of the all-solid lithium secondary battery much depends upon the ionic conduction of the solid electrolyte, namely, of the lithium ionic conductor. Therefore, in order to reduce the internal resistance of the all-solid lithium secondary battery to improve the output characteristic, the ionic conduction of the solid electrolyte, namely, of the lithium ionic conductor, is enhanced.

Particularly, the crystal structure of the solid electrolyte, namely, of the lithium ionic conductor, is one of factors by which the ionic conductivity is varied significantly.

Therefore, it is desired to implement a lithium ionic conductor having a crystal structure having a high ionic conductivity, namely, a solid electrolyte of an all-solid lithium secondary battery, improve the ionic conduction of the lithium ionic conductor, namely, of the solid electrolyte of the all-solid lithium secondary battery, and reduce the internal resistance of the all-solid lithium secondary battery improve the output characteristic of the all-solid lithium secondary battery.

In the following, a lithium ionic conductor, a fabrication method for the lithium ionic conductor and an all-solid lithium secondary battery according to an embodiment are described with reference to the drawings.

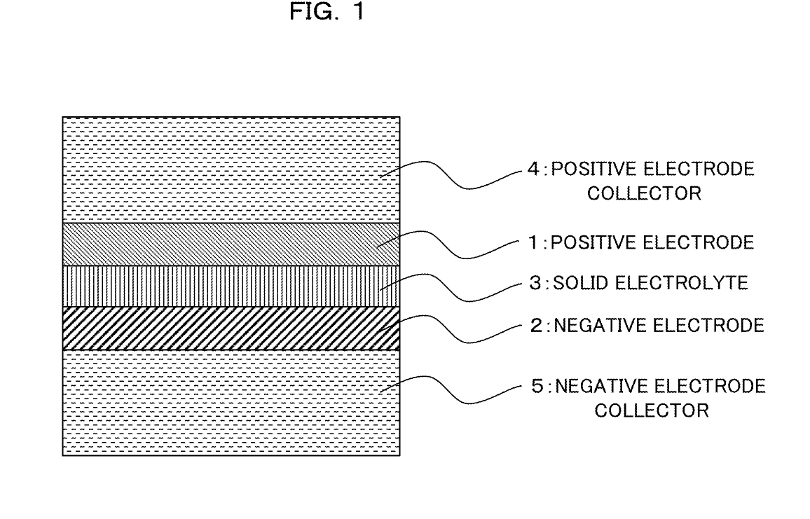

As depicted in FIG. 1, the all-solid lithium secondary battery according to the present embodiment includes a positive electrode 1, a negative electrode 2, a solid electrolyte 3 provided between the positive electrode 1 and the negative electrode 2, and a positive electrode collector 4 and a negative electrode collector 5 provided so as to sandwich the constituent elements 1, 2 and 3 therebetween. Preferably such an all-solid lithium secondary battery as just described is incorporated, for example, in an environment power generation apparatus.

Here, the positive electrode 1 includes a positive electrode active material. Here, the positive electrode 1 contains, for example, LiCoO₂ as the positive electrode active material. In particular, the positive electrode 1 is configured from a material obtained by mixing LiCoO₂ and a solid electrolyte material at a ratio of 6:4.

The negative electrode 2 includes a negative electrode active material. Here, the negative electrode 2 contains, for example, Li—Al as the negative electrode active material. In particular, the negative electrode 2 is configured from a material obtained by mixing Li—Al (alloy) and a solid electrolyte material at a ratio of 7:3.

The solid electrolyte 3 is a lithium ionic conductor and includes lithium (Li), phosphorus (P), boron (B) and sulfur (S) as constituent materials, and has a crystal structure that boron (B) is substituted for part of phosphorus (P) of Li₃PS₄.

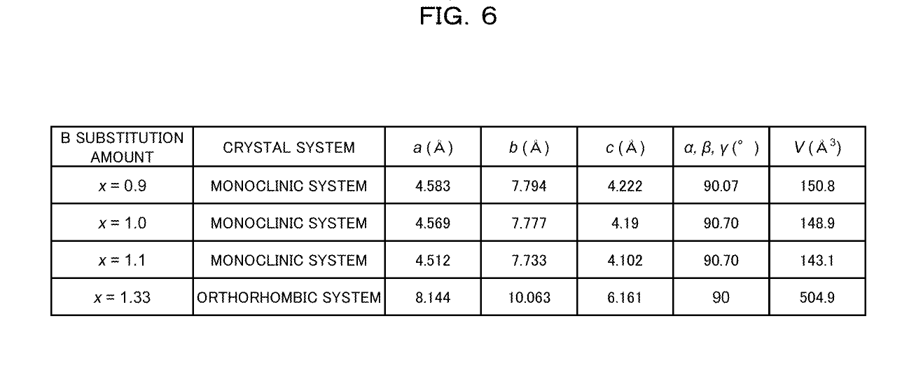

Particularly, the solid electrolyte 3 has a crystal structure including a crystal lattice of a monoclinic system. In particular, as described in the description of the examples (refer to FIG. 6) hereinafter described, the solid electrolyte (lithium ionic conductor) 3 has a crystal structure including a crystal lattice that satisfies a relationship of a≠b≠c where a, b and c are lengths of the axes of a unit lattice and relationships of α and γ=90° and β≠90° where α, β and γ are angles between ridges. The solid electrolyte 3 is different from a solid electrolyte having a crystal structure including a crystal lattice of an orthorhombic system, namely, a solid electrolyte having a crystal structure including a crystal lattice that satisfies a relationship of a≠b≠c where a, b and c are lengths of the axes of a unit lattice and another relationship of α, β and γ=90° where α, β and γ are angles between ridges.

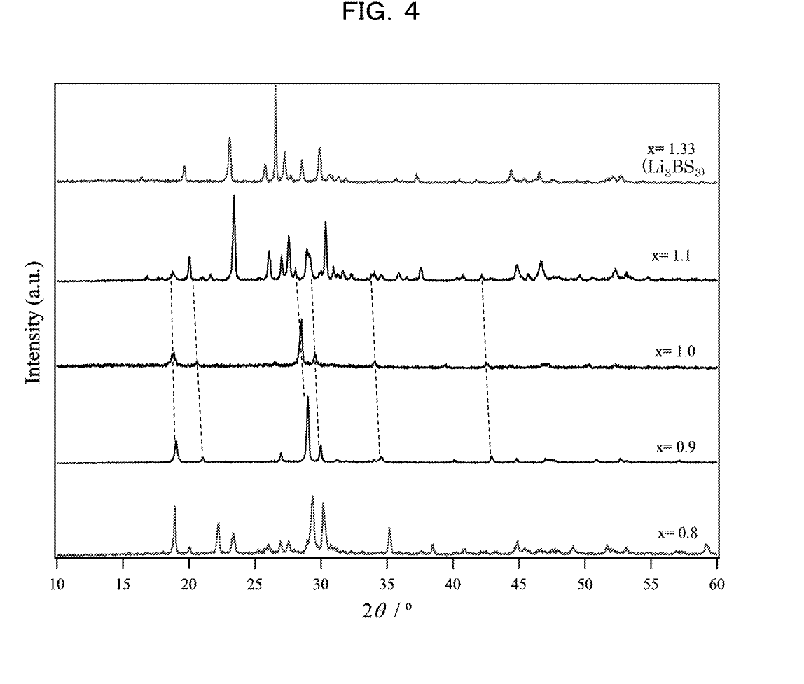

The solid electrolyte 3 having such a crystal structure including a crystal lattice of a monoclinic system as described above has a composition represented by Li_{3+3/4x}BₓP_{1-3/4x}S₄ (0.9≦x≦1.1) on the basis of powder X-ray diffraction data (refer to FIG. 4) in the examples hereinafter described.

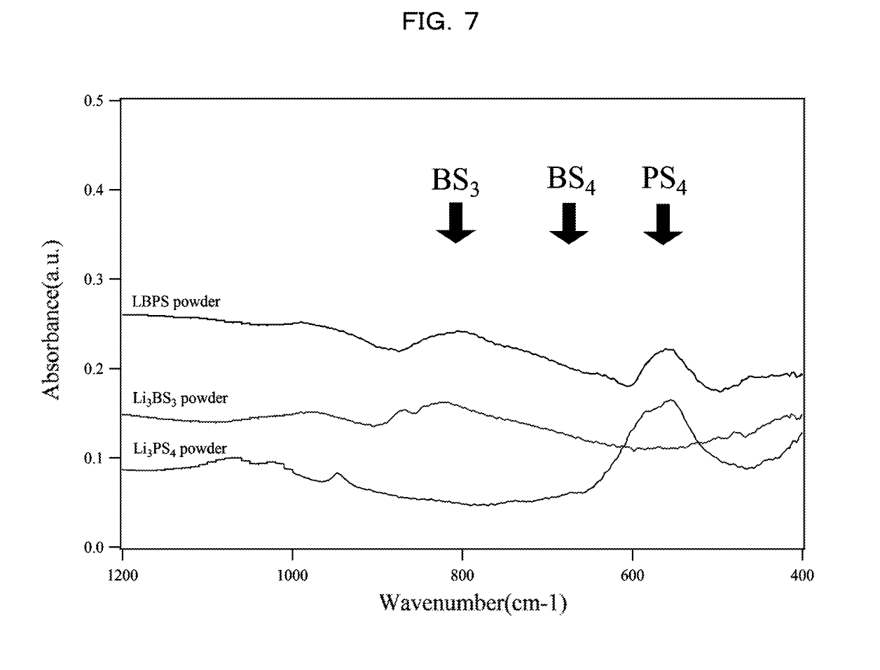

As indicated by a result of measurement (refer to FIG. 7) by infrared spectrometry in the examples hereinafter described, the solid electrolyte 3 having such a crystal structure including a crystal lattice of a monoclinic system as described above has a crystal structure including a skeleton of a three-coordinated planar body centering on boron (B) and a four-coordinated tetrahedron centering on boron (B) and another four-coordinated tetrahedron centering on phosphorus (P). In particular, the solid electrolyte 3 has a crystal structure including a skeleton of a sulfate of BS₃, BS₄ and PS₄, namely, of polyanions. It is to be noted that the three-coordinated planar body centering on boron (B) is a BS₃ planar body and the four-coordinated tetrahedron centering on boron (B) is a BS₄ tetrahedron, and the four-coordinated tetrahedron centering on phosphorus (P) is a PS₄ tetrahedron.

Further, as indicated by power X-ray diffraction data (refer to FIG. 4) in the examples hereinafter described, the solid electrolyte 3 has, in an X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

Such a solid electrolyte 3 as described above can be fabricated by mixing lithium (Li), phosphorus (P), boron (B) and sulfur (S) and melting the mixture by heating and then quenching the melted mixture. In particular, the solid electrolyte 3 described above can be fabricated by quenching the mixture of lithium (Li), phosphorus (P), boron (B) and sulfur (S) from the temperature at which the mixture is melted to a room temperature. It is to be noted that such a synthesis method as just descried is referred to as quenching method, quenching synthesis method or quench method.

By such a solid electrolyte 3 as described above, the solid electrolyte 3 having a crystal structure having a high ionic conductivity can be implemented. Consequently, the ionic conduction of the solid electrolyte 3 can be improved.

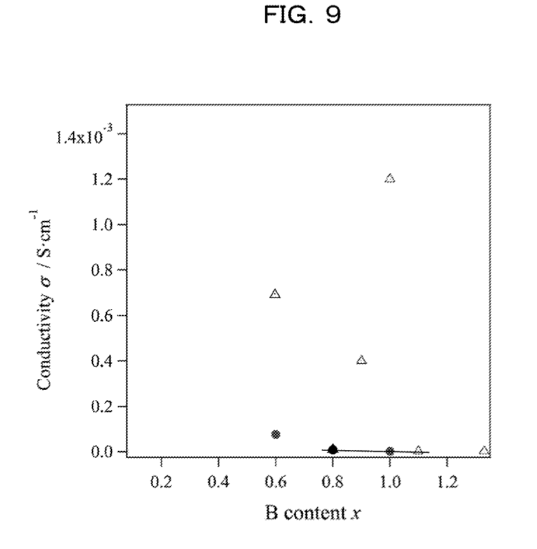

Particularly, as described in the description of the examples (refer to FIG. 9) hereinafter described, by configuring the solid electrolyte 3 so as to have a crystal structure including a crystal lattice of a monoclinic system and a composition represented by Li_{3+3/4x}BₓP_{1-3/4x}S₄ (x=0.9), the solid electrolyte 3 having a high ionic conductivity exceeding 10⁻⁴ S/cm can be implemented. Further, by configuring the solid electrolyte 3 so as to have a crystal structure including a crystal lattice of a monoclinic system and a composition represented by Li_{3+3/4x}BₓP_{1-3/4x}S₄ (x=1.0), the solid electrolyte 3 having a very high ionic conductivity exceeding 10⁻³ S/cm can be implemented. In particular, by configuring the solid electrolyte 3 so as to have a crystal structure including a crystal lattice of a monoclinic system and a composition represented by Li_{3+3/4x}BₓP_{1-3/4x}S₄ (0.9≦x≦1.0), the solid electrolyte 3 having at least a high ionic conductivity exceeding 10⁻⁴ S/cm can be implemented. In this manner, a remarkable effect can be obtained which cannot be obtained by a solid electrolyte wherein, for example, a solid electrolyte having a crystal structure including a crystal lattice of an orthorhombic system such as a β structure or a γ structure of Li₃PS₄, boron (B) is substituted for part of phosphorus (P) of a β structure or a γ structure of Li₃PS₄, or Li_{3+3/4x}BₓP_{1-3/4x}S₄ (x=0.8) or Li_{3+3/4x}BₓP_{1-3/4x}S₄ (x=1.33, namely, Li₃BS₃). It is to be noted that, while the solid electrolyte having a composition represented by Li_{3+3/4x}BₓP_{1-3/4x}S₄ (x=1.1) is a solid electrolyte having a crystal structure including a crystal lattice of a monoclinic system as described above, since the amount of the crystal lattice of a monoclinic system is small, a remarkable effect similar to that obtained by the solid electrolyte having a composition represented by Li_{3+3/4x}BₓP_{1-3/4x}S₄ (x=0.9) or by Li_{3+3/4x}BₓP_{1-3/4x}S₄ (x=1.0) has not been obtained. Further, while the solid electrolyte having a composition represented by Li_{3+3/4x}BₓP_{1-3/4x}S₄ (x=0.6) is a solid electrolyte having a crystal structure including a crystal lattice of an orthorhombic system, it is considered that the ionic conductivity is high arising from the β structure by the synthesis by the quenching method as described above.

Further, since the constituent elements are lithium (Li), phosphorus (P), boron (B) and sulfur (S) and a rare and expensive semimetal element such as, for example, Ge is not used as described above, the production cost can be reduced and the solid electrolyte 3 can be implemented less expensively. Particularly, the present embodiment is effective to suppress the production cost of the all-solid lithium secondary battery where upsizing is taken into consideration.

Further, since boron (B) that is a lighter element than phosphorus (P) is substituted for phosphorus (P) as described above, reduction of the weight of the solid electrolyte 3 can be implemented. For example, it is a significant merit that the weight of a constituent material for a battery can be decreased where a large-size battery is incorporated in a moving body such as an electric automobile.

In this manner, with the solid electrolyte (lithium ionic conductor) 3 of the present embodiment, the solid electrolyte having a high ionic conductivity exceeding, for example, 10⁻³ S/cm can be implemented while the production cost is suppressed and reduction of the weight is achieved.

On the other hand, it has been reported that a solid electrolyte for which, for example, Li₃PS₄ is used as a basis and to which Ge is added indicates, for example, an ionic conduction (bulk impedance) of approximately 10⁻³ S/cm. However, since Ge is a rare and expensive semimetal element, this increases the production cost. Further, since Ge is a comparatively heavy element, this increases the weight.

Accordingly, with the lithium ionic conductor, fabrication method for the lithium ionic conductor and all-solid lithium secondary battery according to the present embodiment, there is an advantage that a lithium ionic conductor having a crystal structure having a high ionic conductivity, namely, the solid electrolyte 3 for the all-solid lithium secondary battery, can be implemented and the ionic conduction of the lithium ionic conductor, namely, of the solid electrolyte 3 for the all-solid lithium secondary battery, can be improved to reduce the internal resistance of the all-solid lithium secondary battery and improve the output characteristic of the all-solid lithium secondary battery.

It is to be noted that the present invention is not limited to the configuration of the embodiment specifically described above, and variations and modifications can be made without departing from the scope of the present invention.

For example, while, in the embodiment described above, the solid electrolyte (lithium ionic conductor) 3 having such a crystal structure as described above is configured so as to have a composition represented by Li_{3+3/4x}BₓP_{1-3/4x}S₄ (0.9≦x≦1.1) on the basis of the powder X-ray diffraction data (refer to FIG. 4) in the examples hereinafter described, the present invention is not limited to this.

In particular, where the solid electrolyte (lithium ionic conductor) 3 is fabricated by the fabrication method (quenching method) of the embodiment described above, if the solid electrolyte 3 is configured so as to have a composition represented by Li_{3+3/4x}BₓP_{1-3/4x}S₄ (0.6≦x≦1.33) on the basis of ionic conductivity data (refer to FIG. 9) of the examples hereinafter described, then the solid electrolyte 3 can be configured so as to have a high ionic conductivity in comparison with that of Li₃PS₄ or Li₃BS₃ fabricated by a different fabrication method. Consequently, the ionic conduction can be improved and the internal resistance of the all-solid lithium secondary battery can be reduced thereby to improve the output characteristic. In particular, if the solid electrolyte (lithium ionic conductor) 3 having a composition represented by Li_{3+3/4x}BₓP_{1-3/4x}S₄ (0.6≦x≦1.33) is fabricated by mixing lithium (Li), phosphorus (P), boron (B) and sulfur (S) and melting the mixture by heating and then quenching the melted mixture, then the solid electrolyte 3 has a high ionic conductivity in comparison with that of Li₃PS₄ or Li₃BS₃ fabricated by a different fabrication method. Consequently, the ionic conduction can be improved and the internal resistance of the all-solid lithium secondary battery can be reduced thereby to improve the output characteristic. It is to be noted that, while at least a solid electrolyte having a composition represented by Li_{3+3/4x}BₓP_{1-3/4x}S₄ (0.9≦x≦1.1) from among solid electrolytes having a composition represented by Li_{3+3/4x}BₓP_{1-3/4x}S₄ (0.6≦x≦1.33) has a crystal structure having a crystal lattice of a monoclinic system, for example, a solid electrolyte having a composition represented by Li_{3+3/4x}BₓP_{1-3/4x}S₄ (x=0.6), Li_{3+3/4x}BₓP_{1-3/4x}S₄ (x=0.8) or Li_{3+3/4x}BₓP_{1-3/4x}S₄ (x=1.33) has a crystal structure that does not include a crystal lattice of a monoclinic system, namely, a crystal structure having a crystal lattice of an orthorhombic system.

Further, on the basis of the ionic conductivity data (refer to FIG. 9) of the example hereinafter described, if the solid electrolyte (lithium ionic conductor) 3 is configured so as to have a composition represented by Li_{3+3/4x}BₓP_{1-3/4x}S₄ (0.6≦x≦1.1) irrespective of the crystal structure and the fabrication method in the embodiment described above, then the solid electrolyte 3 has a high ionic conductivity in comparison with that of Li₃PS₄ or Li₃BS₃. Consequently, the ionic conduction can be improved and the internal resistance of the all-solid lithium secondary battery can be reduced thereby to improve the output characteristic. For example, the solid electrolyte (lithium ionic conductor) 3 having a composition represented by Li_{3+3/4x}BₓP_{1-3/4x}S₄ (0.6≦x≦1.1) can be fabricated also in such a manner as described below. In particular, lithium (Li), phosphorus (P), boron (B) and sulfur (S) are mixed first and the mixture is melted by heating, and then the melted mixture is cooled to form a burned body. Then, the burned body is reduced to powder and burned at a temperature at which it does not melt thereby to fabricate the solid electrolyte (lithium ionic conductor) 3. The solid electrolyte (lithium ionic conductor) 3 fabricated in such a manner as just described has a crystal structure in which boron (B) is substituted for part of phosphorus (P) of the β structure of Li₃PS₄ at a room temperature. Therefore, the β structure having a high ionic conductivity at a room temperature is obtained and the solid electrolyte 3 has a high ionic conductivity in comparison with that of Li₃PS₄ or Li₃BS₃. Consequently, the ionic conduction can be improved and the internal resistance of the all-solid lithium secondary battery can be reduced thereby to improve the output characteristic. It is to be noted that, for details of this, International Publication PCT/JP2011/68618, the entire content of which is incorporated herein by reference, is to be referred to.

It is to be noted that ionic conductivity data of solid electrolytes (lithium ionic conductors) having compositions represented by Li_{3+3/4x}BₓP_{1-3/4x}S₄ (x=0.9) and Li_{3+3/4x}BₓP_{1-3/4x}S₄ (x=1.1) synthesized by a natural cooling method are not plotted in the ionic conductivity data (refer to FIG. 9) of the examples hereinafter described. However, the ionic conductivity of a solid electrolyte (lithium ionic conductor) of the example 8, namely, of a solid electrolyte (lithium ionic conductor) having a composition represented by Li_{3+3/4x}BₓP_{1-3/4x}S₄ (x=0.8) synthesized by a natural cooling method, is 8.8×10⁻⁶ S/cm and the ionic conductivity of a solid electrolyte (lithium ionic conductor) of the example 9, namely, of a solid electrolyte (lithium ionic conductor) having a composition represented by Li_{3+3/4x}BₓP_{1-3/4x}S₄ (x=1.0) synthesized by a natural cooling method, is 2.1×10⁻⁶ S/cm. Thus, within this range, the ionic conductivity varies linearly and can be approximated by a linear line (refer to FIG. 9). Therefore, the ionic conductivities of the solid electrolytes (lithium ionic conductor) having the compositions represented by Li_{3+3/4x}BₓP_{1-3/4x}S₄ (x=0.9) and Li_{3+3/4x}BₓP_{1-3/4x}S₄ (x=1.1) synthesized by a natural cooling method are 5.0×10⁻⁶ S/cm and 9.0×10⁻⁷S/cm, respectively. Accordingly, if the solid electrolyte (lithium ionic conductor) 3 is configured so as to have a composition represented by Li_{3+3/4x}BₓP_{1-3/4x}S₄ (0.6≦x≦1.1) irrespective of the crystal structure or the fabrication method as described hereinabove, then the solid electrolyte 3 can have a high ionic conductivity in comparison with that of Li₃PS₄ or Li₃BS₃. Consequently, the ionic conduction can be improved and the internal resistance of the all-solid lithium secondary battery can be reduced thereby to improve the output characteristic.

It is to be noted that, on the basis of the ionic conductivity data (refer to FIG. 9) of the examples hereinafter described, if a solid electrolyte is fabricated by the fabrication method (quenching method) of the embodiment described above or is configured so as to have a crystal structure including a crystal lattice of a monoclinic system of the embodiment described above, then, in a solid electrolyte having a composition represented by Li_{3+3/4x}BₓP_{1-3/4x}S₄ (0.9≦x≦1.1), a solid electrolyte having a high ionic conductivity exceeding at least 10⁻⁴ S/cm can be implemented and a remarkable effect can be obtained that the ionic conductivity increases remarkably. Further, if the fabrication method (quenching method) of the embodiment described above is used, then, where using any other fabrication method, a solid electrolyte having a composition represented by Li_{3+3/4x}BₓP_{1-3/4x}S₄ (x=1.33) that does not obtain a desired crystal structure and that does not exhibit an ionic conduction comes to have a crystal structure including a crystal lattice of an orthorhombic system and having a high ionic conductivity. Further, if a solid electrolyte having a composition represented by Li_{3+3/4x}BₓP_{1-3/4x}S₄ (x=0.6) is fabricated by the fabrication method (quenching method) of the embodiment described above, then it exhibits remarkable improvement in ionic conductivity in comparison with a solid electrolyte fabricated by a natural cooling method hereinafter described.

### EXAMPLES

In the following, the embodiment is described in more detail with reference to examples. However, the present invention is not limited to the examples described below.

[First Synthesis Method (Quenching Method) of Solid Electrolyte (Lithium Ionic Conductor)]

First, lithium sulfide (Li₂S), phosphorus pentasulfide (P₂S₅), boron (B) and sulfur (S) were mixed using an agate mortar in a glove box to perform pallet molding.

Then, the mixture produced by the pellet molding was encapsulated under reduced pressure into a quartz tube having an inner face covered with glassy carbon and then heated at approximately 800° C., which is a temperature at which the mixture is melted, and kept at the temperature for approximately six hours. Then, the mixture was quenched to a room temperature thereby to obtain a solid electrolyte (lithium ionic conductor).

[Second Synthesis Method (Natural Cooling Method) of Solid Electrolyte (Lithium Ionic Conductor)]

Lithium sulfide (Li₂S), phosphorus pentasulfide (P₂S₂), boron (B) and sulfur (S) were mixed first using an agate mortar in a glove box to perform pallet molding.

Then, the mixture produced by the pellet molding was encapsulated under reduced pressure into a quartz tube having an inner face covered with glassy carbon and then heated to approximately 700° C., which is a temperature at which the mixture is melted, and kept at the temperature for approximately four hours. Then, the mixture was naturally cooled to a room temperature to obtain a burned body (burned sample).

Then, the burned body obtained in such a manner as just described was reduced to powder for approximately 90 minutes using a vibrating cup mill, and the powder was molded by uniaxial press again. Then, the molded burned body was encapsulated under reduced pressure and then burned for approximately eight hours at approximately 550° C. that is a temperature at which the burned body does not melt thereby to obtain a solid electrolyte (lithium ionic conductor).

### Example 1

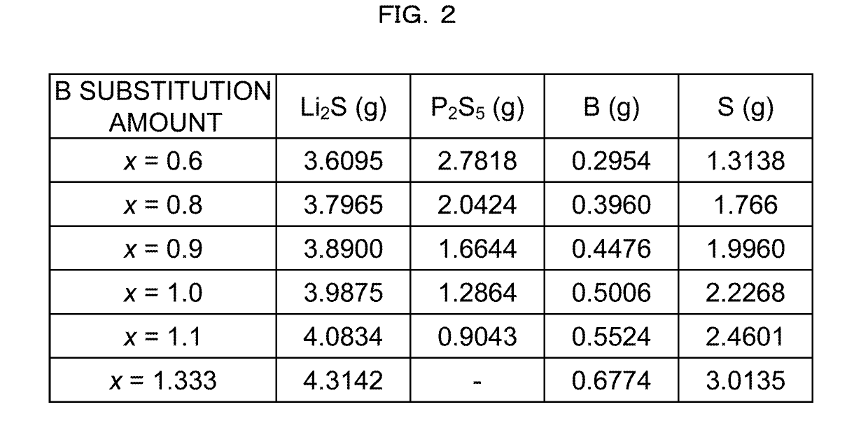

As depicted in FIG. 2, on the basis of a composition ratio in the case of x=0.600 in a Li_{3+3/4x}BₓP_{1-3/4x}S₄ solid solution system, weighing values of lithium sulfide (Li₂S), phosphorus pentasulfide (P₂S₅), boron (B) and sulfur (S) were set to 3.6095 g, 2.7818 g, 0.2954 g and 1.3138 g, respectively. Then, the materials were mixed to obtain a solid electrolyte (lithium ionic conductor) by the first synthesis method (quenching method) described above.

### Example 2

As depicted in FIG. 2, on the basis of a composition ratio in the case of x=0.800 in a Li_{3+3/4x}BₓP_{1-3/4x}S₄ solid solution system, weighing values of lithium sulfide (Li₂S)_{f} phosphorus pentasulfide (P₂S₂), boron (B) and sulfur (S) were set to 3.7965 g, 2.0424 g, 0.3960 g and 1.7660 g, respectively. Then, the materials were mixed to obtain a solid electrolyte (lithium ionic conductor) by the first synthesis method (quenching method) described above.

### Example 3

As depicted in FIG. 2, on the basis of a composition ratio in the case of x=0.900 in a Li_{3+3/4x}BₓP_{1-3/4x}S₄ solid solution system, weighing values of lithium sulfide (Li₂S), phosphorus pentasulfide (P₂S₂), boron (B) and sulfur (S) were set to 3.8900 g, 1.6644 g, 0.4476 g and 1.9960 g, respectively. Then, the materials were mixed to obtain a solid electrolyte (lithium ionic conductor) by the first synthesis method (quenching method) described above.

### Example 4

As depicted in FIG. 2, on the basis of a composition ratio in the case of x=1.000 in a Li_{3+3/4x}BₓP_{1-3/4x}S₄ solid solution system, weighing values of lithium sulfide (Li₂S), phosphorus pentasulfide (P₂S₂), boron (B) and sulfur (S) were set to 3.9875 g, 1.2864 g, 0.5006 g and 2.2268 g, respectively. Then, the materials were mixed to obtain a solid electrolyte (lithium ionic conductor) by the first synthesis method (quenching method) described above.

### Example 5

As depicted in FIG. 2, on the basis of a composition ratio in the case of x=1.100 in a Li_{3+3/4x}BₓP_{1-3/4x}S₄ solid solution system, weighing values of lithium sulfide (Li₂S), phosphorus pentasulfide (P₂S₂), boron (B) and sulfur (S) were set to 4.0834 g, 0.9043 g, 0.5524 g and 2.4601 g, respectively. Then, the materials were mixed to obtain a solid electrolyte (lithium ionic conductor) by the first synthesis method (quenching method) described above.

### Example 6

As depicted in FIG. 2, on the basis of a composition ratio in the case of x=1.333 in a Li_{3+3/4x}BₓP_{1-3/4x}S₄ solid solution system, weighing values of lithium sulfide (Li₂S), phosphorus pentasulfide (P₂S₂), boron (B) and sulfur (S) were set to 4.3142 g, 0 g, 0.6774 g and 3.0135 g, respectively. Then, the materials were mixed to obtain a solid electrolyte (lithium ionic conductor) by the first synthesis method (quenching method) described above.

### Example 7

As depicted in FIG. 2, on the basis of a composition ratio in the case of x=0.600 in a Li_{3+3/4x}BₓP_{1-3/4x}S₄ solid solution system, weighing values of lithium sulfide (Li₂S), phosphorus pentasulfide (P₂S₂), boron (B) and sulfur (S) were set to 3.6095 g, 2.7818 g, 0.2954 g and 1.3138 g, respectively. Then, the materials were mixed to obtain a solid electrolyte (lithium ionic conductor) by the second synthesis method (natural cooling method) described above.

### Example 8

As depicted in FIG. 2, on the basis of a composition ratio in the case of x=0.800 in a Li_{3+3/4x}BₓP_{1-3/4x}S₄ solid solution system, weighing values of lithium sulfide (Li₂S), phosphorus pentasulfide (P₂S₂), boron (B) and sulfur (S) were set to 3.7965 g, 2.0424 g, 0.3960 g and 1.7660 g, respectively. Then, the materials were mixed to obtain a solid electrolyte (lithium ionic conductor) by the second synthesis method (natural cooling method) described above.

### Example 9

As depicted in FIG. 2, on the basis of a composition ratio in the case of x=1.000 in a Li_{3+3/4x}BₓP_{1-3/4x}S₄ solid solution system, weighing values of lithium sulfide (Li₂S), phosphorus pentasulfide (P₂S₂), boron (B) and sulfur (S) were determined to 3.9875 g, 1.2864 g, 0.5006 g and 2.2268 g, respectively. Then, the materials were mixed to obtain a solid electrolyte (lithium ionic conductor) by the second synthesis method (natural cooling method) described above.

### Comparative Example 1

As depicted in FIG. 2, on the basis of a composition ratio in the case of x=1.333 in a Li_{3+3/4x}BₓP_{1-3/4x}S₄ solid solution system, weighing values of lithium sulfide (Li₂S), phosphorus pentasulfide (P₂S₂), boron (B) and sulfur (S) were set to 4.3142 g, 0 g, 0.6774 g and 3.0135 g, respectively. Then, the materials were mixed to obtain a solid electrolyte (lithium ionic conductor) by the second synthesis method (natural cooling method) described above.

### Comparative Example 2

On the basis of a composition ratio where x is set lower than x=0.100 in a Li_{3+3/4x}BₓP_{1-3/4x}S₄ solid solution system, lithium sulfide (Li₂S), phosphorus pentasulfide (P₂S₂), boron (B) and sulfur (S) were mixed to obtain a solid electrolyte (lithium ionic conductor) by the second synthesis method (natural cooling method) described above.

[Evaluation of Solid Electrolyte (Lithium Ionic Conductor)]

First, powder X-ray diffraction measurement was performed to evaluate the crystal structure of the solid electrolytes (lithium ionic conductors) of the examples 1 to 9 and the comparative examples 1 and 2 obtained in such a manner as described above.

Here, as the powder X-ray diffraction measurement, laboratory X-ray diffraction measurement was performed for the solid electrolytes (lithium ionic conductors) of the examples 1 to 9 and the comparative examples 1 and 2. Further, and synchrotron X-ray diffraction measurement was performed for the solid electrolyte (lithium ionic conductor) of the example 4, and infrared spectrometry was performed for the solid electrolyte (lithium ionic conductor) of the example 4.

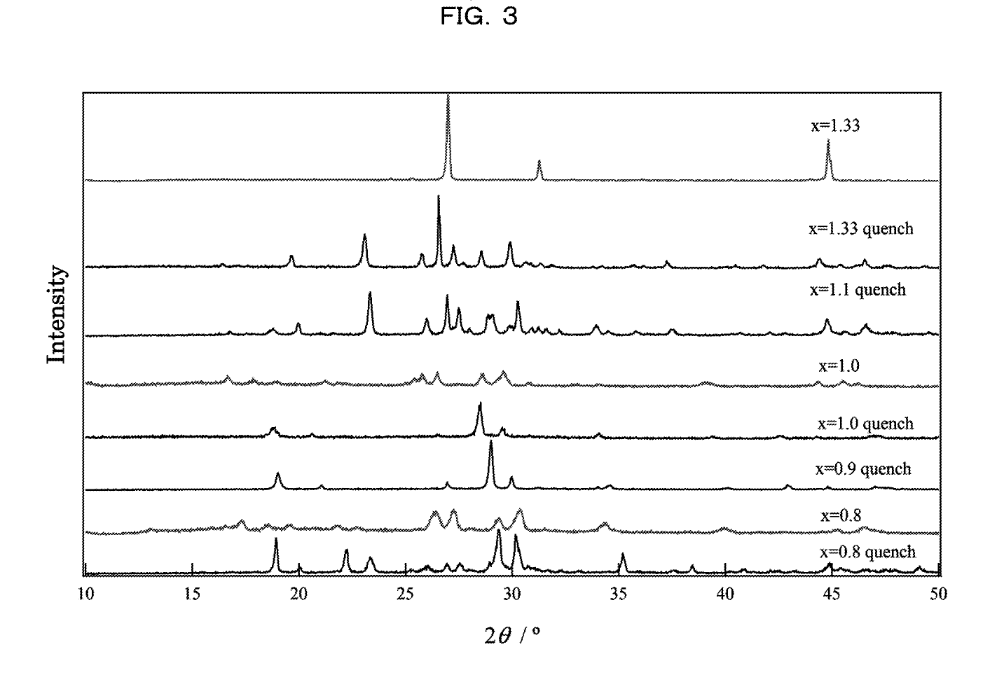

First, in the laboratory X-ray diffraction measurement, the RINT [output voltage (tube voltage) 40 kv, output current (tube current) 30 mA] of Rigaku Corporation was used as the apparatus. Further, using CuKα (CuKα₁: λ=1.5405 Å), the measurement range was set to 10°≦2θ≦60° and the measurement temperature was set to 27° C. (room temperature), and successive measurement was performed at a scanning speed 1.2°/min. As a result, such diffraction diagrams (data) as depicted in FIGS. 3 and 4 were obtained.

Here, FIG. 3 depicts diffraction diagrams obtained by the laboratory X-ray diffraction measurement in the case of the solid electrolytes (lithium ionic conductors) of the examples 2 to 6, 8 and 9 and the comparative example 1. Meanwhile, FIG. 4 depicts diffraction diagrams obtained by the laboratory X-ray diffraction measurement in the case of the solid electrolytes (lithium ionic conductors) of the examples 2 to 6.

As depicted in FIG. 3, where the quenching method was used for the synthesis (examples 2 to 6), diffraction diagrams different from those obtained where the quenching method was not used for the synthesis (examples 8 and 9 and comparative example 1) were obtained.

In particular, a peak indicating a β structure was found in the diffraction diagrams of the solid electrolytes (lithium ionic conductors) of the examples 8 and 9 (x=0.800, 1.000) from among the examples 8 and 9 and the comparative example 1 in which the quenching method was not used for the synthesis. In particular, the solid electrolytes (lithium ionic conductors) of the examples 8 and 9 (x=0.800, 1.000) indicated a crystal structure in which boron (B) is substituted for part of phosphorus (P) of the β structure of Li₃PS₄ at a room temperature. It is to be noted that, though not depicted, a peak indicating a β structure was found also in the diffraction diagrams of the solid electrolytes (lithium ionic conductors) of the example 1 (x=0.600) in which the quenching method was used for the synthesis and the example 7 (x=0.600) in which the quenching method was not used for the synthesis. In particular, the solid electrolytes (lithium ionic conductors) of the examples 1 and 7 (x=0.600), indicated a crystal structure in which boron (B) is substituted for part of phosphorus (P) of the β structure of Li₃PS₄ at a room temperature. Further, while the diffraction diagram of the solid electrolyte (lithium ionic conductor) of the comparative example 1 (x=1.333) indicated a peak of its raw material, it did not indicate a peak indicating a γ structure or a β structure. In other words, the solid electrolyte (lithium ionic conductor) of the comparative example 1 (x=1.333) did not have any of a y structure and a β structure.

In contrast, in the solid electrolytes (lithium ionic conductors) of the examples 2 to 6 (x=0.800, 0.900, 1.000, 1.100, 1.333) in which the quenching method was used for the synthesis, a crystal structure different from that described above was obtained.

In particular, in the diffraction diagrams of the solid electrolytes (lithium ionic conductors) of the examples 3 to 5 (x=0.900, 1.000, 1.100) from among the examples 2 to 6 in which the quenching method was used for the synthesis, peaks indicating a crystal lattice of a monoclinic system (six peaks coupled through a dotted line in FIG. 4) were found. In this manner, the solid electrolytes of the examples 3 to 5 (x=0.900, 1.000, 1.100) individually had a crystal structure including a crystal lattice of a monoclinic system. In the diffraction diagrams of the solid electrolytes (lithium ionic conductors) of the examples 3 to 5 (x=0.900, 1.000, 1.100), a diffraction peak was found at 2θ=18.83±0.5 deg, 20.60±0.5 deg, 28.52±0.5 deg, 29.53±0.5 deg, 34.09±0.5 deg and 39.37±0.5 deg.

In contrast, in the diffraction diagrams of the solid electrolytes (lithium ionic conductors) of the examples 2 and 6 (x=0.800, 1.333), a peak indicating a crystal lattice of a monoclinic system was not found, but a peak indicating a crystal lattice of an orthorhombic system was found. In particular, the solid electrolytes (lithium ionic conductors) of the examples 2 and 6 (x=0.800, 1.333) individually had a crystal structure that does not include a crystal lattice of a monoclinic system, namely, a crystal structure that includes a crystal lattice of an orthorhombic system. It is to be noted that also the solid electrolytes (lithium ionic conductors) of the examples 1 and 7 to 9 (x=0.600, 0.800, 1.000) individually had a crystal structure that includes a crystal lattice of an orthorhombic system.

In this manner, while the solid electrolytes (lithium ionic conductors) of the examples 3 to 5 synthesized by the quenching method individually had a crystal structure that includes a crystal lattice of a monoclinic system, the solid electrolytes (lithium ionic conductors) of the examples 1, 2 and 6 to 9 individually had a crystal structure that includes a crystal lattice of an orthorhombic system. The composition of the solid electrolytes (lithium ionic conductors) having the crystal structure including a crystal lattice of a monoclinic system is represented by Li_{3+3/4x}BₓP_{1-3/4x}S₄ (0.9≦x≦1.1) on the basis of the powder X-ray diffraction data depicted in FIG. 4.

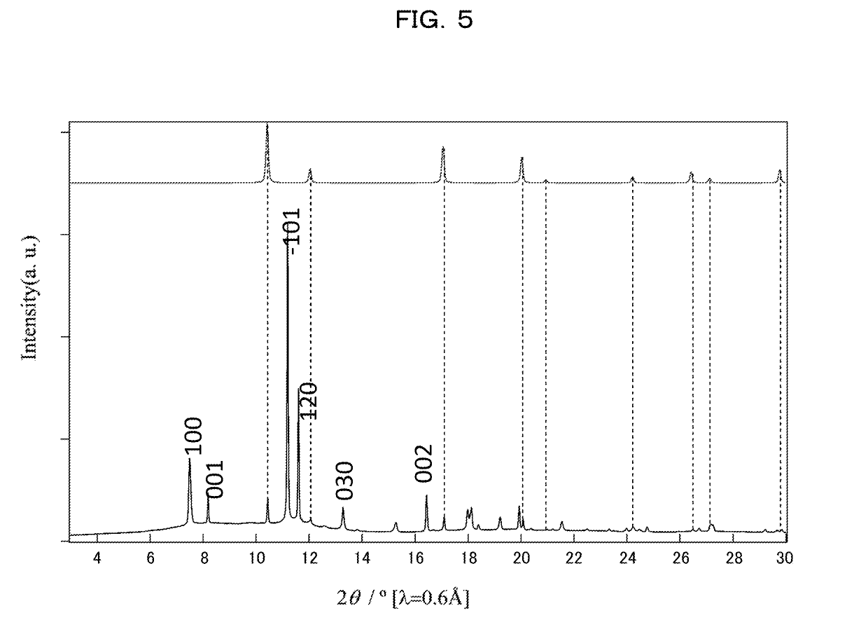

Next, in the synchrotron X-ray diffraction measurement, the synchrotron radiation facilities SPring-8 and beam line BL19B2 was used, the wavelength was set to 0.6 Å and the measurement temperature range was set to −180° C. to 300° C., and measurement was performed for the solid electrolyte (lithium ionic conductor) of the example 4 (x=1.000) and such a diffraction diagram (diffraction data) as depicted in FIG. 5 was obtained. It is to be noted that data of Li₂S that was the raw material is depicted at the upper side in FIG. 5.

Here, six peaks other than a peak corresponding to the peak of Li₂S of the raw material indicated by a dotted line in FIG. 5 were extracted. It is to be noted that the six peaks correspond to six peaks coupled through a dotted line in FIG. 4. Then, as depicted in FIG. 5, an index is allocated to each of the six peaks to calculate a lattice constant using calculation software for index allocation named DICVOL06.

As a result, as depicted in FIG. 6, the solid electrolyte (lithium ionic conductor) of the example 4 (x=1.000) indicated that the lengths a, b and c of the axes of a unit lattice were 4.569 Å, 7.777 Å and 4.19 Å, respectively; the angles α, β and γ between ridge lines were 90°, 90.70° and 90°, respectively; and the volume V was 148.9 Å³. In this manner, the solid electrolyte (lithium ionic conductor) of the example 4 (x=1.000) had a crystal structure including a crystal lattice in which the relationship of the lengths a, b and c of the axes of a unit lattice satisfied a≠b≠c and the relationship of the angles α, β and γ between ridge lines satisfied α, γ=90° and β≠90°. In other words, the solid electrolyte (lithium ionic conductor) of the example 4 (x=1.000) had a crystal structure including a crystal lattice of a monoclinic system.

Similarly, the radiation X-ray diffraction measurement was performed also for the solid electrolytes (lithium ionic conductors) of the examples 3 and 5 (x=0.900, 1.100) to obtain diffraction diagrams. Thus, six peaks were extracted, and a lattice constant was calculated.

As a result, as depicted in FIG. 6, the solid electrolyte (lithium ionic conductor) of the example 3 (x=0.900) indicated that the lengths a, b and c of the axes of a unit lattice were 4.583 Å, 7.794 Å and 4.222 Å, respectively; the angles α, β and γ between ridge lines were 90°, 90.07° and 90°, respectively; and the volume was V 150.8 Å³. In this manner, the solid electrolyte (lithium ionic conductor) of the example 3 (x=0.900) had a crystal structure including a crystal lattice in which the relationship of the lengths a, b and c of the axes of a unit lattice satisfied a≠b≠c and the relationship of the angles α, β and γ between ridge lines satisfied α, γ=90° and β≠90°. In other words, the solid electrolyte (lithium ionic conductor) of the example 3 (x=0.900) had a crystal structure including a crystal lattice of a monoclinic system.

Meanwhile, the solid electrolyte (lithium ionic conductor) of the example 5 (x=1.100) exhibited that the lengths a, b and c of the axes of a unit lattice were 4.512 Å, 7.733 Å and 4.102 Å, respectively; the angles α, β and γ between ridge lines were 90°, 90.70° and 90°, respectively; and the volume V was 143.1 Å³. In this manner, the solid electrolyte (lithium ionic conductor) of the example 5 (x=1.100) had a crystal structure including a crystal lattice in which the relationship of the lengths a, b and c of the axes of a unit lattice satisfied a≠b≠c and the relationship of the angles α, β and γ between ridge lines satisfied α, γ=90° and β≠90°. In other words, the solid electrolyte (lithium ionic conductor) of the example 5 (x=1.100) had a crystal structure including a crystal lattice of a monoclinic system.

In this manner, the solid electrolytes (lithium ionic conductors) of the examples 3 to 5 (x=0.900, 1.000, 1.100) indicated that the lengths a, b and c of the axes of a unit lattice were approximately 4.51 to approximately 4.58 Å, approximately 7.73 to approximately 7.79 Å and approximately 4.10 to approximately 4.22 Å, respectively; the angles α, β and γ between ridge lines were 90°, approximately 90.1° to approximately 90.7° and 90°, respectively; and the volume V was approximately 143 to 151 Å³. In this manner, the solid electrolytes (lithium ionic conductors) of the examples 3 to 5 (x=0.900, 1.000, 1.100) had a crystal structure including a crystal lattice in which the relationship of the lengths a, b and c of the axes of a unit lattice satisfied a≠b≠c and the relationship of the angles α, β and γ between ridge lines satisfied α, γ=90° and β≠90°. In other words, the solid electrolytes (lithium ionic conductors) of the examples 3 to 5 (x=0.900, 1.000, 1.100) individually had a crystal structure including a crystal lattice of a monoclinic system and individually had a composition represented by Li_{3+3/4x}BₓP_{1-3/4x}S₄ (0.9≦x≦1.1).

In contrast, the solid electrolyte (lithium ionic conductor) of the example 6 (x=1.333) indicated that the lengths a, b and c of the axes of a unit lattice were 8.144 Å, 10.063 Å and 6.161 Å, respectively; the angles α, β and γ between ridge lines were 90°, 90° and 90°, respectively; and the volume V was 504.9 Å³. In this manner, the solid electrolyte (lithium ionic conductor) of the example 6 (x=1.333) had a crystal structure including a crystal lattice in which a relationship of the lengths a, b and c of the axes of a unit lattice satisfied a≠b≠c and the relationship of the angles α, β and γ between ridge lines satisfied α, β and γ=90°. In other words, the solid electrolyte (lithium ionic conductor) of the example 6 (x=1.333) had a crystal structure including a crystal lattice of an orthorhombic system.

Next, in the infrared spectrometry, measurement was performed for the solid electrolyte (lithium ionic conductor) of the example 4 (x=1.000) using a Fourier Transform Infrared Spectrometer (FT-IR), and such spectrum data as depicted in FIG. 7 was obtained. It is to be noted that also spectrum data of Li₃BS₃ and Li₃PS₄ are depicted in FIG. 7. Here, the Nocolet 8700 Fourier transform infrared spectrometer of Thermoelectron was used as an apparatus, and the resolution was set to 4 cm⁻¹; and the integration time period was set to 256 times (5 minutes), and a KBr pellet method was used as a measurement method.

As depicted in FIG. 7, peaks indicating BS₃, BS₄ and PS₄ were found in the spectrum data of the solid electrolyte (lithium ionic conductor) of the example 4 (x=1.000). In particular, the solid electrolyte (lithium ionic conductor) of the example 4 (x=1.000) had a crystal structure including a skeleton of a three-coordinated planar body (BS₃ planar body) centering on boron (B), a four-coordinated tetrahedron (BS₄ tetrahedron) centering on boron (B) and another four-coordinated tetrahedron (PS₄ tetrahedron) centering on phosphorus (P).

Further, when the infrared spectrometry was performed similarly also for the solid electrolytes (lithium ionic conductors) of the examples 3 and 5 (x=0.900, 1.100) to obtain spectrum data, peaks indicating BS₃, BS₄ and PS₄ were found similarly. In other words, also the solid electrolytes (lithium ionic conductors) of the examples 3 and 5 (x=0.900, 1.100) individually had a crystal structure including a skeleton of a three-coordinated planar body (BS₃ planar body) centering on boron (B), a four-coordinated tetrahedron (BS₄ tetrahedron) centering on boron (B) and another four-coordinated tetrahedron (PS₄ tetrahedron) centering on phosphorus (P).

In this manner, the solid electrolytes (lithium ionic conductors) of the examples 3 to 5 (x=0.900, 1.000, 1.100) individually had a crystal structure including a skeleton of a three-coordinated planar body (BS₃ planar body) centering on boron (B), a four-coordinated tetrahedron (BS₄ tetrahedron) centering on boron (B) and another four-coordinated tetrahedron (PS₄ tetrahedron) centering on phosphorus (P).

Then, ionic conductivity measurement was performed to evaluate the ionic conductivity of the solid electrolytes (lithium ionic conductors) of the examples 1 to 9 and the comparative examples 1 and 2 obtained in such a manner as described above.

The valuation of the ionic conductivity was performed using an alternating current impedance method.

In particular, the solid electrolytes (lithium ionic conductors) of the examples 1 to 9 and the comparative examples 1 and 2 described above were individually attached to an electrochemical cell having a jig [here, the upper side thereof is an electrode terminal (+) and the lower side thereof was an electrode terminal (−)] of 10 mmφ for which SKD11 was used as a material and AUTOLAB FRA (frequency response analysis apparatus) of Metrohm Autolab was used as an evaluation apparatus. Further, the application voltage was set to 0.1 V; the frequency response region was set to 1 MHz to 1 Hz; and the measurement temperature was set to 27° C. (room temperature), and then the impedance was measured.

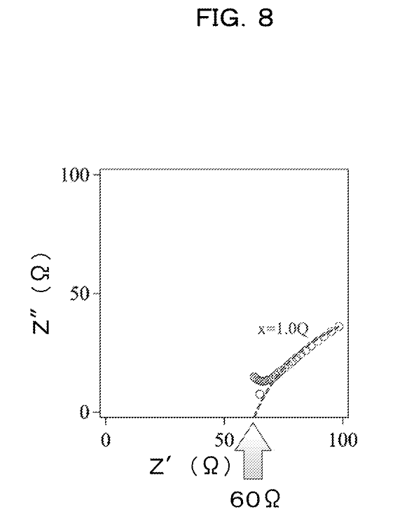

Then, as depicted in FIG. 8, one circular arc was extrapolated to measured data of the impedance and the ionic conductivity was calculated taking an crossing point between the right end and the Z′ axis as grain boundary resistance. Here, the thickness of the solid electrolyte (lithium ionic conductor) was set to t (cm); the area (electrode area) of the jig used for the measurement was set to S (cm²); and the resistance value of the grain boundary resistance was set to R (Ω), and the ionic conductivity σ (S/cm) was calculated in accordance with the following expression.

t (cm)/R(Ω)/S (cm²)=σ(1/Ω·cm)=σ (S/cm)

For example, in the case of the example 4 (X=1.000), σ=1.2×10⁻³ S/cm was calculated using t=0.06 cm, R=60Ω and S=0.785 cm².

Here, FIG. 9 depicts ionic conductivity data of the solid electrolytes (lithium ionic conductors) of the examples 1 to 9 described above at a room temperature (here, approximately 27° C.) in various cases. It is to be noted that the ionic conductivity data of the examples 1 to 6 are plotted using a mark of a triangle and the ionic conductivity data of the examples 7 to 9 are plotted using a mark of a black circle.

As depicted in FIG. 9, the ionic conductivity of the solid electrolyte (lithium ionic conductor) of the example 1 (x=0.600; quenching method) was 6.9×10⁻⁴ S/cm; the ionic conductivity of the solid electrolyte (lithium ionic conductor) of the example 2 (x=0.800; quenching method) was 8.8×10⁻⁶ S/cm; the ionic conductivity of the solid electrolyte (lithium ionic conductor) of the example 3 (x=0.900; quenching method) was 4.0×10⁻⁴S/cm; the ionic conductivity of the solid electrolyte (lithium ionic conductor) of the example 4 (x=1.000; quenching method) was 1.2×10⁻³ S/cm; the ionic conductivity of the solid electrolyte (lithium ionic conductor) of the example 5 (x=1.100; quenching method) was 2.0×10⁻⁶ S/cm; the ionic conductivity of the solid electrolyte (lithium ionic conductor) of the example 6 (x=1.333; quenching method) was 3.1×10⁻⁶ S/cm; the ionic conductivity of the solid electrolyte (lithium ionic conductor) of the example 7 (x=0.600; natural cooling method) was 7.7×10⁻⁵ S/cm; the ionic conductivity of the solid electrolyte (lithium ionic conductor) of the example 8 (x=0.800; natural cooling method) was 8.8×10⁻⁶ S/cm; and the ionic conductivity of the solid electrolyte (lithium ionic conductor) of the example 9 (x=1.000; natural cooling method) was 2.1×10⁻⁶ S/cm.

In contrast, since the solid electrolyte (lithium ionic conductor) of the comparative example 1 (x=1.333; natural cooling method) did not indicate an ionic conduction, the data of the comparative example 1 are not plotted in FIG. 9. Further, since the ionic conductivity of the solid electrolyte (lithium ionic conductor) of the comparative example 2 (x<0.100; natural cooling method) was lower than 10⁻⁶S/cm, the data of the comparative example 2 are not plotted in FIG. 9. For example, although Li₃PS₄ is included in a case in which x is lower than 0.100, the ionic conductivity is lower than 10⁻⁶ S/cm at a room temperature. Further, while Li₃BS₃ is included in a case in which x is 1.333, an ionic conduction is not indicated at a room temperature.

In this manner, the solid electrolytes (lithium ionic conductors) of the examples 1 to 9 indicate high ionic conductivities at a room temperature and indicate improved ionic conduction in comparison with those of the solid electrolytes (lithium ionic conductors) of the comparative examples 1 and 2.

For example, the solid electrolyte (lithium ionic conductor) of the example 4 was fabricated by the quenching method and has a crystal structure including a crystal lattice of a monoclinic system as described above. In contrast, the solid electrolytes (lithium ionic conductors) of the examples 1 and 2 were fabricated by the quenching method and individually have a crystal structure including a crystal lattice of an orthorhombic system, and the solid electrolytes (lithium ionic conductors) of the examples 7 to 9 were fabricated by the natural cooling method and individually have a crystal structure including a crystal lattice of an orthorhombic system. However, the solid electrolytes (lithium ionic conductors) of the examples 1, 2, 4 and 7 to 9 indicated high ionic conductivities and indicated improved ionic conduction in comparison with the solid electrolytes (lithium ionic conductors) of the comparative examples 1 and 2. In this manner, on the basis of the ionic conductivity data (refer to FIG. 9) of the example described above, if the solid electrolyte (lithium ionic conductor) is configured so as to have a composition represented by Li_{3+3/4x}BₓP_{1-3/4x}S₄ (0.6≦x≦1.1) irrespective of the crystal structure or the fabrication method, then the ionic conductivity becomes high and the ionic conduction is improved in comparison with those of the solid electrolytes (lithium ionic conductors) of the comparative examples 1 and 2.

Further, while, in the ionic conductivity data (refer to FIG. 9) of the examples described above, ionic conductivity data of the solid electrolytes (lithium ionic conductors) synthesized by the natural cooling method and having compositions represented by Li_{3+3/4x}BₓP_{1-3/4x}S₄ (x=0.9) and Li_{3+3/4x}BₓP_{1-3/4x}S₄ (x=1.1) are not plotted, the ionic conductivity of the solid electrolyte (lithium ionic conductor) of the example 8 is 8.8×10⁻⁶ S/cm and the ionic conductivity of the solid electrolyte (lithium ionic conductor) of the example 9 is 2.1×10⁻⁶ S/cm, and the ionic conductivity varies linearly within the ranges and can be approximated by a linear line (refer to FIG. 9). Therefore, on the basis of this, the ionic conductivities of the solid electrolytes (lithium ionic conductors) synthesized by the natural cooling method and having compositions represented by Li_{3+3/4x}BₓP_{1-3/4x}S₄ (x=0.9) and Li_{3+3/4x}BₓP_{1-3/4x}S₄ (X=1.1) are 5.0×10⁻⁶S/cm and 9.0×10⁻⁷S/cm, respectively. Further, while the solid electrolytes (lithium ionic conductors) synthesized by the natural cooling method and having a composition represented by Li_{3+3/4x}BₓP_{1-3/4x}S₄ (x=0.9) has a crystal structure including a crystal lattice of an orthorhombic system, the solid electrolyte (lithium ionic conductor) of the example 3 was fabricated by the quenching method and has a crystal structure including a crystal lattice of a monoclinic system. However, the solid electrolyte (lithium ionic conductor) synthesized by the natural cooling method and having a composition represented by Li_{3+3/4x}BₓP_{1-3/4x}S₄ (x=0.9) and the solid electrolyte (lithium ionic conductor) of the example 3 indicate high ionic conductivities and indicate improved ionic conduction in comparison with those of the solid electrolytes (lithium ionic conductors) of the comparative examples 1 and 2. Further, while the solid electrolytes (lithium ionic conductors) synthesized by the natural cooling method and having a composition represented by Li_{3+3/4x}BₓP_{1-3/4x}S₄ (x=1.1) have a crystal structure including a crystal lattice of an orthorhombic system, the solid electrolyte (lithium ionic conductor) of the example 5 was fabricated by the quenching method and has a crystal structure including a crystal lattice of a monoclinic system. However, the solid electrolytes (lithium ionic conductors) synthesized by the natural cooling method and having a composition represented by Li_{3+3/4x}BₓP_{1-3/4x}S₄ (x=1.1) and the solid electrolyte (lithium ionic conductor) of the example 5 indicate high ionic conductivities and indicate improved ionic conduction in comparison with those of the solid electrolytes (lithium ionic conductors) of the comparative examples 1 and 2. Accordingly, if the solid electrolyte (lithium ionic conductor) is configured so as to have a composition represented by Li_{3+3/4x}BₓP_{1-3/4x}S₄ (0.6≦x≦1.1) irrespective of the crystal structure or the fabrication method, then the ionic conductivity becomes high and the ionic conduction is improved in comparison with those of the solid electrolytes (lithium ionic conductors) of the comparative examples 1 and 2.

Especially, the example 4 (x=1.000; quenching method) has a very high ionic conductivity exceeding 10⁻³ S/cm. In particular, by using the quenching method as in the example 4 (x=1.000), the ionic conductivity is increased significantly and the ionic conduction is improved significantly in comparison with the example 9 (x=1.000) in which the natural cooling method is used. Further, if the solid electrolyte is configured so as to have a crystal structure including a crystal lattice of a monoclinic system and have a composition represented by Li_{3+3/4x}BₓP_{1-3/4x}S₄ (x=1.0) as in the example 4 (x=1.000), then the ionic conductivity is increased significantly and the ionic conduction is improved significantly.

Further, the solid electrolyte (lithium ionic conductor) of the example 3 (x=0.900; quenching method) has a high ionic conductivity exceeding 10⁻⁴ S/cm. In particular, by configuring the solid electrolyte (lithium ionic conductor) so as to have a crystal structure including a crystal lattice of a monoclinic system and have a composition represented by Li_{3+3/4x}BₓP_{1-3/4x}S₄ (x=0.9), a solid electrolyte having a high ionic conductivity exceeding 10⁻⁴ S/cm can be implemented. Further, the solid electrolyte (lithium ionic conductor) of the example 4 (x=1.000; quenching method) has a very high ionic conductivity exceeding 10⁻³ S/cm. In particular, by configuring the solid electrolyte (lithium ionic conductor) so as to have a crystal structure including a crystal lattice of a monoclinic system and have a composition represented by Li_{3+3/4x}BₓP_{1-3/4x}S₄ (x=1.0), a solid electrolyte having a very high ionic conductivity exceeding 10⁻³ S/cm can be implemented. In this manner, from among the solid electrolytes (lithium ionic conductors) of the examples 2 to 6 in which the quenching method was used, the solid electrolytes (lithium ionic conductors) of the example 3 (x=0.900; quenching method) and the example 4 (x=1.000; quenching method) indicate suddenly increased ionic conductivities and indicate suddenly improved ionic conduction in comparison with the solid electrolyte (lithium ionic conductor) of the example (x=0.800; quenching method), the solid electrolytes (lithium ionic conductors) of the example 5 (x=1.100; quenching method) and the example 6 (x=1.333; quenching method). In short, by configuring the solid electrolyte (lithium ionic conductor) so as to have a crystal structure including a crystal lattice of a monoclinic system and have a composition represented by Li_{3+3/4x}BₓP_{1-3/4x}S₄ (0.9≦x≦1.0), a remarkable effect can be achieved which has not been achieved by solid electrolytes having a crystal structure including a crystal lattice of an orthorhombic system such as Li_{3+3/4x}BₓP_{1-3/4x}S₄ (x=0.8) or Li_{3+3/4x}BₓP_{1-3/4x}S₄ (x=1.33; namely, Li₃BS₃). It is to be noted that, while the solid electrolyte (lithium ionic conductor) of the example 1, namely, a solid electrolyte having a composition represented by Li_{3+3/4x}BₓP_{1-3/4x}S₄ (x=0.6), has a crystal structure including a crystal lattice of an orthorhombic system, it is expected that, by the synthesis by the quenching method, the ionic conductivity is increased arising from the β structure.

Further, the solid electrolytes (lithium ionic conductors) of the example 3 (x=0.900; quenching method) and the example 4 (x=1.000; quenching method) indicate significantly increased ionic conductivities and indicate significantly improved ionic conduction in comparison with the solid electrolytes (lithium ionic conductors) of the example 8 (x=0.800; natural cooling method), the example 9 (x=1.000; natural cooling method), comparative example 1 (x=1.333; natural cooling method) and comparative example 2 (x<0.100; natural cooling method). In particular, by configuring the solid electrolyte (lithium ionic conductor) so as to have a crystal structure including a crystal lattice of a monoclinic system and have a composition represented by Li_{3+3/4x}BₓP_{1-3/4x}S₄ (0.9≦x≦1.0), a remarkable effect can be obtained which has not been achieved by solid electrolytes having, for example, a crystal structure including a crystal lattice of an orthorhombic system such as a β structure or a γ structure of Li₃PS₄, boron (B) is substituted for part of phosphorus (P) of a β structure or a γ structure of Li₃PS₄, or Li_{3+3/4x}BₓP_{1-3/4x}S₄ (x=0.8) or Li_{3+3/4x}BₓP_{1-3/4x}S₄ (x=1.33; namely, Li₃BS₃).

Further, as described above, the solid electrolytes (lithium ionic conductors) of the examples 1 to 6 in which the quenching method was used indicate increased ionic conductivities and indicate improved ionic conduction in comparison with the solid electrolytes (lithium ionic conductors) of the examples 7 to 9 and comparative examples 1 and 2 in which the natural cooling method was used. Especially, while the solid electrolyte (lithium ionic conductor) of the comparative example 1 (x=1.333) in which the natural cooling method was used did not achieve a desired crystal structure and indicated no ionic conduction, the solid electrolyte (lithium ionic conductor) of the example 6 (x=1.333) in which the quenching method was used has a high ionic conductivity. Further, the solid electrolyte (lithium ionic conductor) of the example 1 (x=0.600) in which the quenching method was used indicates a significantly improved ionic conductivity in comparison with that of the solid electrolyte (lithium ionic conductor) of the example 7 (x=0.600) in which the natural cooling method was used. In this manner, where a solid electrolyte (lithium ionic conductor) is fabricated by the quenching method, by configuring the solid electrolyte so as to have a composition represented by Li_{3+3/4x}BₓP_{1-3/4x}S₄ (0.6≦x≦1.33), the ionic conductivity becomes high and the ionic conduction is improved in comparison with the solid electrolyte fabricated by the natural cooling method or Li₃PS₄.

[Fabrication Method for all-Solid Lithium Secondary Battery]

First, LiCoO₂ and a solid electrolyte material (here, that of the example 4) synthesized in such a manner as described above were mixed at a ratio of 6:4 to produce the positive electrode 1.

Then, Li—Al and a solid electrolyte material (here, that of the example 4) synthesized in such a manner as described above were mixed at a ratio of 7:3 to produce the negative electrode 2.

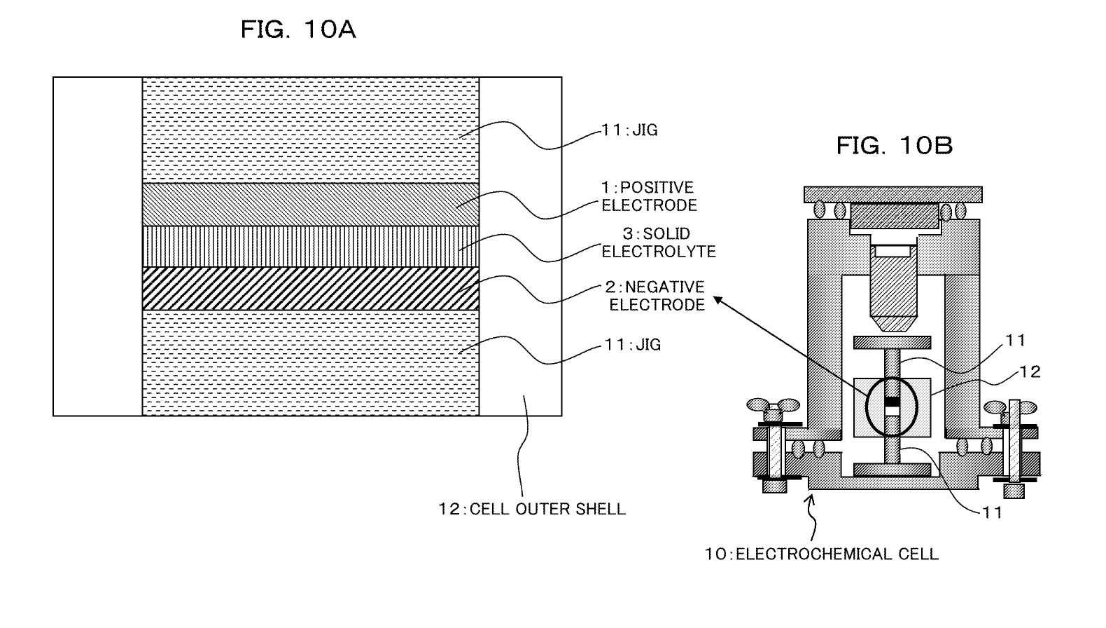

Then, as depicted in FIGS. 10(A) and 10(B), the negative electrode 2, solid electrolyte (here, that of the example 4) 3 and positive electrode 1 were stacked in order in a space between jigs 11 of 10 mmφ provided in the electrochemical cell 10 and then pressurized to produce an all-solid lithium secondary battery. It is to be noted that reference numeral 12 in FIGS. 10(A) and 10(B) denotes a cell (cell outer shell).

[Evaluation of all-Solid Lithium Secondary Battery]

Charge and discharge evaluation of the all-solid lithium secondary battery produced in such a manner as described above was performed.

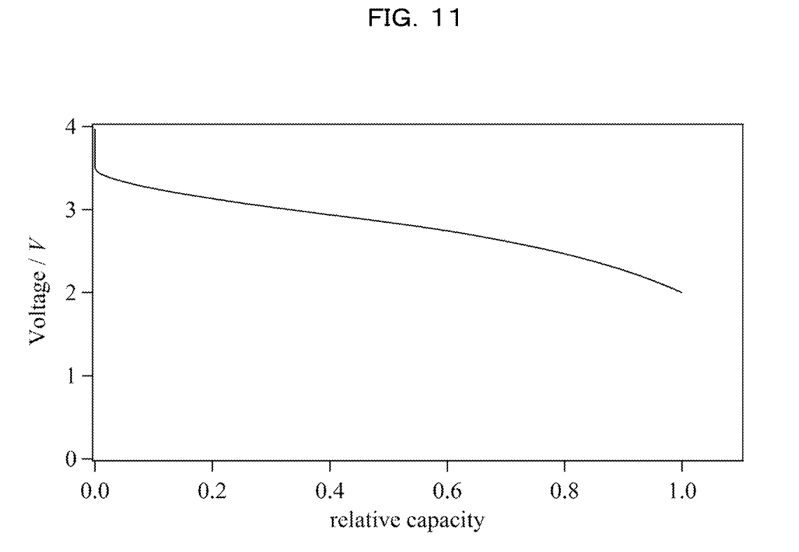

With the all-solid lithium secondary battery produced in such a manner as described above, namely, with an all-solid lithium secondary battery including the solid electrolyte (here, of the example 4) 3 synthesized in such a manner as described above, battery operation at a room temperature was confirmed successfully and such a discharge curve as depicted in FIG. 11 was obtained. Consequently, a good load characteristic (output characteristic) was obtained.

In contrast, when an all-solid lithium secondary battery including a solid electrolyte formed from Li₃PS₄ (comparative example 2) or Li₃BS₃ (comparative example 1) was produced and charge and discharge evaluation was performed, the all-solid lithium secondary battery did not operate. In other words, the all-solid lithium secondary battery including a solid electrolyte formed from Li₃PS₄ or Li₃BS₃ did not operate as a battery because the internal resistance is excessively high. Consequently, a discharge curve was not obtained.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A lithium ionic conductor, comprising lithium (Li), phosphorus (P), boron (B) and sulfur (S) as constituent elements and comprising a crystal structure including a crystal lattice of a monoclinic system.

2. The lithium ionic conductor according to claim 1, wherein the lithium ionic conductor has a composition represented by Li_{3+3/4x}BₓP_{1-3/4x}S₄ (0.9≦x≦1.1).

3. The lithium ionic conductor according to claim 1, wherein the lithium ionic conductor has, in an X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

4. The lithium ionic conductor according to claim 1, wherein the lithium ionic conductor has a crystal structure including a skeleton of a three-coordinated planar body centering on boron (B), a four-coordinated tetrahedron centering on boron (B) and another four-coordinated tetrahedron centering on phosphorus (P).

5. A lithium ionic conductor, comprising lithium (Li), phosphorus (P), boron (B) and sulfur (S) as constituent elements, and comprising, in an X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

6. A lithium ionic conductor, comprising a composition represented by Li_{3+3/4x}BₓP_{1-3/4x}S₄ (0.6≦x≦1.1).

7. An all-solid lithium secondary battery, comprising:
a positive electrode;
a negative electrode; and
a solid electrolyte that is provided between the positive electrode and the negative electrode, contains lithium (Li), phosphorus (P), boron (B) and sulfur (S) as constituent elements and has a crystal structure including a crystal lattice of a monoclinic system.

8. The all-solid lithium secondary battery according to claim 7, wherein the solid electrolyte has a composition represented by Li_{3+3/4x}BₓP_{1-3/4x}S₄ (0.9≦x≦1.1).

9. The all-solid lithium secondary battery according to claim 7, wherein the solid electrolyte has, in an X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

10. The all-solid lithium secondary battery according to claim 7, wherein the solid electrolyte has a crystal structure including a skeleton of a three-coordinated planar body centering on boron (B), a four-coordinated tetrahedron centering on boron (B) and another four-coordinated tetrahedron centering on phosphorus (P).

11. An all-solid lithium secondary battery, comprising:
a positive electrode;
a negative electrode; and
a solid electrolyte that is provided between the positive electrode and the negative electrode, contains lithium (Li), phosphorus (P), boron (B) and sulfur (S) as constituent elements and has, in an X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

12. An all-solid lithium secondary battery, comprising:
a positive electrode;
a negative electrode; and
a solid electrolyte provided between the positive electrode and the negative electrode and having a composition represented by Li_{3+3/4x}BₓP_{1-3/4x}S₄ (0.6≦x≦1.1).

13. A fabrication method for a lithium ionic conductor, comprising mixing lithium (Li), phosphorus (P), boron (B) and sulfur (S), melting the mixture by heating, and quenching the melted mixture to fabricate a solid electrolyte having a crystal structure including a crystal lattice of a monoclinic system.

14. The fabrication method for a lithium ionic conductor according to claim 13, wherein the solid electrolyte has a composition represented by Li_{3+3/4x}BₓP_{1-3/4x}S₄ (0.9≦x≦1.1).

15. The fabrication method for a lithium ionic conductor according to claim 13, wherein the solid electrolyte has, in an X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

16. The fabrication method for a lithium ionic conductor according to claim 13, wherein the solid electrolyte has a crystal structure including a skeleton of a three-coordinated planar body centering on boron (B), a four-coordinated tetrahedron centering on boron (B) and another four-coordinated tetrahedron centering on phosphorus (P).

17. A fabrication method for a lithium ionic conductor, comprising mixing lithium (Li), phosphorus (P), boron (B) and sulfur (S), melting the mixture by heating, and quenching the melted mixture to fabricate a solid electrolyte having, in X-ray diffraction (CuKα₁: λ=1.5405 Å), a diffraction peak at 2θ=18.83±0.5 deg, 20.60±0.5 deg, 28.52±0.5 deg, 29.53±0.5 deg, 34.09±0.5 deg and 39.37±0.5 deg.

18. A fabrication method for a lithium ionic conductor, comprising mixing lithium (Li), phosphorus (P), boron (B) and sulfur (S), melting the mixture by heating, and quenching the melted mixture to fabricate a solid electrolyte having a composition represented by Li_{3+3/4x}BₓP_{1-3/4x}S₄ (0.6≦x≦1.33).
